(19) United States
(12) Patent Application Publication
(10) Pub. No.: US 2009/0315704 A1
(43) Pub. Date: Dec. 24, 2009

(54) Method and Integrated System for Tracking Luggage

(75) Inventors: Howard Stephen Rosing, Naples, FL (US); Richard John Cross, Atlanta, GA (US)

Correspondence Address: PATENT CORRESPONDENCE;ARNALL GOLDEN GREGORY LLP, 171 17TH STREET NW, SUITE 2100, ATLANTA, GA, 30363, US

(73) Assignee: Global Biomedical Development, LLC, a Georgia limited liability company, Naples, FL (US)

(21) Appl. No.: 12/141,992

(22) Filed: Jun. 19, 2008

(51) Int. Cl. G08B 1/08

(52) U.S. Cl. 340/539.13

(57) ABSTRACT

The present invention provides a luggage finder that uses navigation system technology to locate baggage. A navigation system beacon device (NSBD) is stored in, on or near a luggage item, and is turned off and on respectively by an accelerometer during take-off and landing of aircraft, such that the transmitted reporting signal is disabled while the plane is in flight. A signal from the NSBD is transmitted to a central server, from which the location of the baggage is communicated to its owner by an email message or by a posting at a web site that can be accessed by the owner.

### FIELD OF THE INVENTION

The invention relates in general to a system and method for monitoring and tracking luggage. The invention relates more particularly to autonomous reporting of luggage locations by means of a navigation system beacon device whose outgoing signal is toggled on and off by autonomous means, such as for silencing during flight.

### BACKGROUND OF THE INVENTION

According to the U.S. Department of Transportation, 4.4 million cases of lost, delayed, pilfered or damaged baggage on U.S. flights were reported in 2007, i.e., 7 incidents for every 1,000 passengers, and the figures are rising. (February 28 Air Travel Consumer Report, pp. 34-36, http://airconsumer.ost.dot.gov/reports/2008/feburary/200802atcr.pdf). Partly in response, air passenger bills of rights have recently been enacted in some U.S. states as well as in Europe; among other effects they penalize airlines more strictly for losing luggage. However though the recent statutes have further sensitized airlines and their regulators to the severity of the luggage problem, no effective long-term solution has yet emerged. Moreover passengers still have limited recourse for self-help if luggage is lost by an airline or any other transportation service. The problem is heightened because luggage contents are often needed imminently for an important time-sensitive event, such as a wedding, business meeting, recreational travel itinerary, or critical sales presentation.

As a partial response airlines are now adopting radio-frequency identification (RFID) tags for baggage, largely because the error rate for RFID scanners is only about 0.5%, significantly less than the scanning errors that arise because of line-of-sight limitations in bar codes that had been in prior use for this purpose. But despite the improved accuracy, RFID and bar code scanners can still locate baggage items only in the immediate vicinity of a scanner. In the common case where it is not clear whether a bag ever left the cargo hold or other storage bins of a plane that has returned to the air, or if it did, where the bag was removed from the plane, such scanners provide no efficient solution. Alternative approaches have now been disclosed that attempt to locate baggage by long-distance methods. Those include the following.

U.S. Pat. No. 6,847,892 to Zhou et al. teaches at column 66 a wrist-watch size device comprising a GPS receiver, transceiver, and data storage attached to bags at the checking counter and taken off after baggage claim, in which the device could potentially be used to locate lost luggage. Alternatively Zhou et al. discloses that bag owners and manufacturers could employ such devices on their own initiative, and the owner could request to locate the bag via a call center or web site.

U.S. Pat. No. 6,697,103 to Fernandez et al. teaches an integrated combination of GPS tracking with imaging sensors to detect movement for (criminal) surveillance purposes; the named embodiments include luggage.

U.S. Pat. No. 5,751,246 to Hertel et al. discloses at claim 16 a system in which a control logic unit configured with a GPS receiver transmits location data for a piece of luggage lost in transit by an airline to a remote location in response to an interrogation query. Then the interrogation means further communicates with airline personnel available to receive the luggage.

U.S. Pat. Pub. No. 2007/0222587 A1 to Crider et al. discloses use of a global positioning satellite (GPS) system as an anti-theft device. There an electronic luggage tag tracks luggage and records the specific times and places at which the luggage is opened. The luggage tag has an implanted GPS chip and a separate device for receiving a transmitted signal from the luggage tag.

U.S. Pat. App. Pub. No. 2007/0007751 A1 to Dayton et al. discloses at claims 10 and 17 a wheeled luggage device in which a retractable handle on the upper portion of the body contains an electronic device that may be a GPS device, and in which the electronic device is configured to deactivate when the handle is retracted.

U.S. Pat. App. Pub. No. 2006/0266563 A1 to Kaplan at paragraphs 0066-0067 teaches supplementing electronic circuitry in luggage to determine its weight at will using a load/force sensor, with the optional inclusion of other electronics such as a GPS device or RFID tag to track the location of a bag and its owner.

U.S. Pat. App. Pub. No. 2006/00087432 A1 to Corbett Jr. teaches the use of an interrogator unit that can receive signals and process information, with the objective of locating personal effects left by travelers in their hotel rooms. The interrogator unit is placed on or in an item of luggage to monitor the presence of items of personal value that are each equipped with an electronic signaling device and RFID tag or GPS chip.

U.S. Pat. App. Pub. No. 2005/0137890 A1 to Bhatt et al. teaches the use of programmable fingerprint scanners to identify and control the movement of suitcases associated with respective individual travelers, for purposes of traveler security.

Int. Pat. App. Pub. No. WO 03/065270 A2 to Degiulo et al. (Accenture, LLP) teaches a tracking system for tracking assets such as freight and incorporating business intelligence. GPS and RFID wireless signaling are combined with a status tracking manager structure unit and a tracking manager unit to provide real time status information about asset movements to clients.

Japanese Pat. App. Pub. No. 2001-175983 to Masayuki et al. (NEC Mobile Commun. Ltd.) relates location data of a client on the site of collection/delivery for luggage. The location data are received from a GPS receiver in the collection/delivery of luggage; the client's name and telephone number is read by a voucher-reader from a voucher attached to the luggage. The location and client data are related and edited as link data at a control terminal, are transmitted by radio signal to an operating center, stored and held in a data base, and are read into a PC, and data processing is exeucted.

Laid-Open German Pat. App. Pub. No. DE 195 08 684 A1 to Stark discloses a transmitter connected to a GPS receiver, which after activation transmits the positional data received to a central monitoring station. When the GPS receiver and transmitter are hidden at a valuable object to be protected, and when an activator there is activated and thus activates the GPS receiver as well, the system serves as an electronic system protecting valuable objects from unauthorized removal.

Several problems remain, however. External devices such as GPS-equipped luggage tags may be damaged during baggage handling. GPS tags and other GPS peripheral devices may also be removed or disabled by thieves, particularly when the devices are bulky enough to attract attention. Constant or frequent data collection and transmissions may drain the batteries of a GPS device before it reaches the destination, especially on long flights and particularly because of the high power requirements of many GPS devices. And not least, federal regulations would forbid radio-frequency transmissions by GPS units during a flight because of the potential for interference with avionics.

Thus there is an ongoing need for solutions that can locate luggage from a distance and enable travelers to track and recover their baggage directly using real-time information.

### BRIEF SUMMARY OF THE INVENTION

The present invention provides a luggage finder that uses navigation system technology to locate luggage. In one embodiment a navigation system beacon device (NSBD) is placed in or on a suitcase or other baggage. The NSBD has components that can receive a signal bearing position information from a location such as a satellite or ground station or aquatic station. The NSBD then stores information, and when permitted, transmits information. The NSBD's output signal is toggled off and on by an accelerometer respectively during (or prior to or following) take-off and landing of an aircraft, or is prevented from toggling on during flight, such that the output reporting signal is disabled while the aircraft is in flight. When the NSBD is enabled its output signal is transmitted to a central server continually, periodically or on demand. In the toggled-on mode the NSBD transmits a signal that communicates position information and optionally time and date information related to the NSBD's location. After the position information is received at the central server, a client receives a report. The report to the client may be by telephone, email, text message, voice message, transmission to a hand-held navigational device, posted entry at a client-accessible website, or other media. The actual location of the luggage may be computed at the NSBD unit, at the central server, or at a navigational device or website accessible to the client, or by some combination of these.

In one embodiment the invention is a method for tracking the location of a piece of luggage, comprising:

a) placing a NSBD in close proximity to the piece of luggage;

b) receiving a transmission of position information at a component of the NSBD;

c) storing position information at a component of the NSBD; and

d) transmitting a signal from the NSBD to report position information;

wherein the NSBD's ability to transmit position information is toggled off under the control of an accelerometer when an aircraft containing the piece of luggage takes off and or the NSBD's ability to transmit position information is toggled on under the control of the accelerometer during or after the landing of the aircraft, or wherein the toggling on or off of the NSBD's transmission capacity is constrained by a history circuit comprising an accelerometer..

In a second embodiment the invention is a method for tracking the location of a piece of luggage, comprising:
a) receiving a transmission of position information from a satellite or ground station at a component of a NSBD that is in close proximity to a piece of luggage;
b) storing the position information at a component of the NSBD;
c) optionally calculating the position of the luggage based on the position information received from the satellite or ground station, wherein the calculation is performed at a component of the NSBD;
d) transmitting a signal from the NSBD to a central server to report position information, but wherein
   i) the NSBD's ability to transmit position information is toggled off under the control of an accelerometer when an aircraft containing the piece of luggage takes off, and or
   ii) the NSBD's ability to transmit position information is toggled on under the control of an accelerometer during or after the landing of the aircraft, and or
   iii) the toggling on or off of the NSBD's transmission capacity is constrained by a history circuit comprising an accelerometer;
e) calculating the position of the luggage at a component of the central server based on the position information received by the NSBD from the satellite or ground station, if the position of the luggage had not been calculated at a component of the NSBD;
f) transmitting position information from the central server to a client email address or client-accessible web page entry, wherein the transmission reports position information for the luggage.

In another embodiment the invention comprises a self-locating luggage unit, wherein the luggage unit comprises a piece of luggage in close proximity to a NSBD, the NSBD comprising:
a) a component that can receive transmissions of position information;
b) a component that can store position information;
c) a component that can transmit position information; and
d) an accelerometer under the control of which the NSBD's transmission ability can be toggled off during take-off and toggled on during landing or after landing of an aircraft in which the luggage unit is located, or wherein the toggling on or off of the NSBD's transmission capacity is constrained by a history circuit comprising said accelerometers.

In still another embodiment the invention comprises an integrated system for tracking the location of a piece of luggage, comprising:
a) the piece of luggage;
b) a NSBD in close proximity to the piece of luggage wherein the NSBD comprises
   i) a component that can receive transmissions of position information;
   ii) a component that can store position information;
   iii) a component that can transmit position information; and
   iv) an accelerometer under the control of which the NSBD's transmission ability can be toggled off during take-off and toggled on during landing or after landing of an aircraft in which the luggage unit is located, or under the control of which the toggling on or off of the NSBD's transmission capacity is constrained by a history circuit comprising said accelerometer;
c) a central server that can receive position information from the NSBD's transmissions and communicate position information to a client; and
d) a means for sending position information in an email to the client from the central server, and or a web site accessible to the client wherein the web site is capable of receiving and displaying luggage position information.

### BRIEF DESCRIPTION OF THE DRAWINGS

FIG. 1 is a schematic caricature illustrating an exemplary embodiment of an integrated system for luggage tracking according to the invention.

FIG. 2 is a flow diagram illustrating an exemplary embodiment of communication flows in an integrated system for luggage tracking according to the invention.

FIG. 3 is a schematic caricature illustrating an exemplary embodiment of a self-locating luggage unit according to the invention.

FIG. 4 is a flow diagram illustrating an exemplary embodiment of signal processing in a NSBD whose transmitter toggle switch is activated or deactivated according to the invention.

FIG. 5 is a flow diagram illustrating an exemplary embodiment of signal processing in a NSBD whose transmitter toggle switch is activated or deactivated according to navigational information received from a plurality of navigational data sources.

### DETAILED DESCRIPTION OF THE INVENTION

The present invention provides a navigation system beacon device (NSBD) in close proximity to an item of luggage, and method of using the NSBD in which the distinctive characteristic g-force and or speed profile of lift-off and landing are used as the basis for toggling the NSBD output signals off and on, respectively. The NSBD receives position signals from external navigation beacons such as satellite, ground and aquatic navigation assistance stations, and—when the transmission mode is toggled on—communicates continually, periodically or on demand to a remote central server the information received from the navigation stations and or position information for the luggage calculated on the basis of data received from the navigation station. The central server then communicates continually, periodically or on demand to a client by a transmission such as email or text messaging or a hand-held navigational device, or by a posting data on a client-accessible website. The actual location of the luggage may be computed at the NSBD unit, at the central server, or at a navigational device or online service accessible to the client, or by some combination of these. During (or optionally prior to or after) aircraft take-off and landing, respectively, the NSBD's signal is toggled off and on under the control of a circuit containing an accelerometer, such that the output reporting signal is disabled while the aircraft is in flight but other otherwise enabled or capable of being activated. In another embodiment the NSBD's signal is prevented from toggling on during flight by a history circuit that recognizes take-off and landing with the aid of one or more accelerometers. The report to the client may be by email, text message, voice message, or by a posted entry at a client-accessible website.

### Definitions

Particular terms recited in this description of the invention have the following meanings.

The term “luggage” or “baggage” as used herein are synonymous and refer to a container for the transport of personal effects or other items during travel, including but not limited to: suitcases; garment bags; duffel bags; footlockers; steamer trunks; equipment cases; lock boxes; shipping boxes; exhibition cases; tool chests; wine cases; tubes for protecting rolled documents; envelopes and cartons for flat documents; flat portfolio cases such are used for artwork; protective cases for musical instruments; crates for transporting pets or other animals; sports gear such as bats, rackets, golf bags, ball bags and the like; wheelchairs and other specialized luggage for disabled patrons; rolling luggage carts and carriers; and so forth. The term luggage as used herein includes appended items such as luggage tags, and when they are attached to the luggage includes peripheral items such as wheeled conveyances. The term luggage as used herein includes carry-on items such as but not limited to purses, briefcases, computer bags, overnight bags, loose garments, and bags and cartons of gifts or souvenirs, as well as luggage stored in the cargo bay of an aircraft. The term “item” or “piece” as used herein with respect to luggage refers to a unit of luggage.

The term “tracking” as used herein refers to identifying the location or the movement history of an item of luggage and is used synonymously with the term monitoring. The term location as used herein with respect to an item of luggage refers to a location identifiable by geographic or navigational coordinates.

The term “navigation system beacon device” (NSBD) as used herein refers to a device that is capable of receiving signals electronically, storing data received from such signals and or data processed from such signals, transmitting a signal, and having at least its transmission capacity toggled off and or on—and or constrained from being toggled off and or on—by a switch in response to a threshold accelerometer value and optionally time value. By the term “component” of an NSBD is meant a functional unit within the NSBD that is capable of an electronic activity such as receiving, storing, transmitting, computing, detecting acceleration, detecting speed, or switching. The term “beacon” as used herein refers to the signaling function of an NSBD. When in use an NSBD comprises or is in electrical connection with a power source such as a battery, hardwired electrical outlet, fuel cell, super capacitor, induction coil, generator or other power supply.

The term “close proximity” as used herein with respect to an item of luggage refers to a freestanding position inside the item, an attached position inside the item, an attached position outside the item, or a location within an integral part of the luggage itself.

The term “position information” as used herein refers to geographic and or navigational coordinates and or time information for a satellite or other station broadcasting navigational information, and or refers to geographic and or navigational coordinates and or time information for an NSBD. The term “report” as used herein with respect to position information refers to transmitting such information to a central server or a client as a summary or in full or in a converted form such as by calculating luggage location from triangulation of relative satellite locations. The terms “position” and “location” are used interchangeably herein.

The term “self-locating” as used herein refers to autonomous detection and transmission of position information that is relevant to remote identification of the location of the self-locating unit. In particular the term self-locating is used here in with respect to NSBD's and items of luggage that are tracked by means of NSBD's.

The term “central server” as used herein refers to a device that receives and sorts and or processes electronic information for distribution to a client. The central server may be a computer of a commercial luggage-tracking service, or may for instance be nothing more than a router or switchboard for sorting and relaying emails or wireless telephone calls.

The term “client” as used herein refers to a person who is tracking or monitoring luggage and receives or accesses information from a central server.

The term “toggle” as used herein refers to activating or deactivating one or more functions on an NSBD including at least toggling transmission from the NSBD.

The term “accelerometer” as used herein refers to a device for detecting threshold levels of acceleration and or deceleration. The term “accelerometric” as used herein refers to the capacity of a device to detect said threshold levels.

The terms “under the control of an accelerometer,” “under the control of a circuit containing an accelerometer,” and “under the control of a circuit comprising an accelerometer” refers to a switch whose toggling is controlled directly or indirectly by the response of an accelerometer to threshold levels of acceleration and or deceleration. As the terms in quotation marks in this paragraph are used herein the toggling may occur in response to a detected or computed level of acceleration or deceleration, or in response to a threshold end velocity such as where the acceleration or deceleration is determined over a specific time, or in response to another physical parameter that can be determined with the aid of an accelerometer. As used herein the terms in quotation marks in this paragraph include but are not limited to embodiments in which a switch for an NSBD comprises a plurality of independent alternative means to measure a threshold level of velocity or other physical parameter, wherein at least one of those alternative independent means comprises an accelerometer.

The term “history circuit” as used herein refers to a circuit that recognizes a relationship between an acceleration event and a deceleration event in proper sequence by means of an accelerometer or a circuit under the control of an accelerometer.

The term “constrains” or “constraint” as used herein with respect to a history circuit and toggling refers to the use of a history circuit in an electronic switch that can prevent a NSBD from being toggled on remotely and or by manual toggling.

The term “override” as used herein refers to a manual or remote reversal of the activation status for an NSBD transmitter, i.e., toggling on or off in a manner contrary to the autonomous position dictated by an accelerometer or history circuit that normally governs the on/off mode.

The term “takeoff” as used herein refers to the departure phase of an aircraft from the ground at the outset of a flight. The term “landing” as used herein refers to the return phase of an aircraft to the ground at the end of a flight. The term “lift-off” as used herein refers to the vertical lifting of an aircraft during takeoff. The term “aircraft” as used herein refers without limit to aircraft that carry passengers, especially commercial aircraft, and includes airplanes, helicopters, balloons such as blimps, and other aircraft such as are familiar to those of ordinary skill in the art of commercial flight.

The term “navigation system” refers to a system for broadcasting geographic and or navigational position information from discrete sites or equipment.

The term “satellite” as used herein refers to a navigation satellite such as but not limited to a satellite in the constellation of the GPS system. The terms “ground station” and “aquatic station” as used herein refer to navigational broadcast stations that are based on land or a body of water, respectively.

The terms “telephone”, “email”, “text message” and “web page” as used herein have their respective normal and customary meanings. The term “client-accesible” as used herein with respect to a web page refers to publicly accessible web pages and web pages accessible to clients by means of a security code.

The term “hand-held navigational device” as used herein refers to a position-finding device such as a consumer GPS device or comparable device.

The terms “GPS,” and “assisted GPS,” as used herein have their ordinary and common meaning in the field of navigational technology.

The term “inertial navigational system” as used herein has its ordinary and common meaning in the field of navigational technology.

### Current Navigation Guidance Systems

Numerous navigation guidance systems exist; these are exemplified as a broad class by the global navigation satellite system (GNSS), which is the standard generic term for satellite navigation systems that provide autonomous geo-spatial positioning with global coverage. A GNSS allows small electronic receivers to determine their location (longitude, latitude, and altitude) to within a few meters using time signals transmitted along line of sight by radio from satellites. Receivers on the ground with a fixed position can also be used to calculate the precise time. As of 2007, the U.S. NAVSTAR Global Positioning System (GPS) was the only fully functional operational GNSS, and is currently based on 31 Medium Earth Orbit satellites (about 20,200 km above the earth) in non-uniform orbits; each satellite transmits precise microwave signals and at least six satellites are within the line of sight for almost every place on the earth's surface. However other systems are also under development. The Russian GLONASS is being restored to full operation. And the European Union's Galileo positioning system is being deployed, with full operations expected by 2013.

Regional satellite navigation systems also exist, though the scope of some may become global. China's Beidou navigation system is currently a candidate for expansion into a global system titled “Compass” based on 30 Medium Earth Orbit satellites and five geostationary satellites. India's IRNSS is under development as a next-generation GNSS, with full operations expected by 2012. Japan's QZSS system is another regional system.

GNSS-1 is the first-generation system and includes the combination of existing satellite navigation systems (GPS and GLONASS) with satellite- or ground-based augmentation systems (SBAS and GBAS, respectively). Various regions have their own SBAS, including the U.S. Wide Area Augmentation System (WAAS), the European Geostationary Navigation Overlay System (EGNOS), the Japanese Multi-Functional Satellite Augmentation System (MSAS) and the Indian GAGAN. Examples of GBAS include the Local Area Augmentation System (LAAS), regional CORS networks, Australian GRAS, and U.S. Department of Transportation National Differential GPS (DGPS) service, as well as the local GBAS using a single GPS reference station operation Real Time Kinematic (RTK) corrections.

GNSS-2 is the second generation of systems for independent civilian navigation, such as Europe's Galileo system. They assign L1 and L2 frequencies for civil use and L5 for system integrity. Adoption of the same frequency assignment system for GPS is intended to make it a GNSS-2 system. The GPS uses L1 (1575.42 MHz, currently for navigation message, coarse-acquisition code and encrypted precision military code); L2 (1227.60 MHz, encrypted military precise code); L3 (1381.05 MHz, used by the Nuclear Detonation Detection System Payload); L4 (1379.913 MHz, for potential use with additional ionospheric protection); and L5 (1176.45 MHz, proposed for civilian Safety-of-Life (SoL signal))

The GNSS systems have evolved from earlier ground-based systems (DECCA, LORAN, and Omega) that were based on terrestrial longwave radio transmitters and pulses from “master” and “slave” ground stations, in which comparative delay between reception and sending allowed location to be fixed. GNSS systems operate more directly: a satellite transmits its position in a data message superimposed on a code that serves as a timing reference, and timing is synchronized for all satellites in a constellation by an atomic clock. The signal's time-of-flight is calculated by subtracting the encoded transmission time from the reception time. When several such measurements are made at the same time relative to different satellites, the GNSS allows a continual fix on position to be determined in real time, essentially by triangulation. Where the receiver is fast-moving, this is somewhat complicated both by the change in distance from the various satellites and by the effect of the angle at which radio signals pass through the ionosphere. Typically the basic computation attempts to find the shortest directed line tangent to four oblate spherical shells centered on four satellites. The receivers reduce errors by using combinations of signals from multiple satellites and multiple correlators, and then using techniques such as Kalman filtering to combine the noisy, partial, and constantly varying data into a single estimate for position, time, and velocity.

Each GPS satellite continuously broadcasts a navigation message at 50 bit/s, in 30-second frames of 1500 bits each. The first part of the message (6 seconds) provides the time of day, GPS week number and satellite health data; the second part of the message (12 more seconds) is an ephemeris giving the satellite's own precise orbit, updated every 2 hours and generally valid for twice that; and the later part of the message is an almanac (the final 12 seconds: coarse orbit and status data for each satellite in the constellation) but the almanac is only provided in increments of 1/25 so 12.5 minutes are required to receive the entire almanac from the satellite. The almanac standardizes time, corrects for ionosphere error, and facilitates the receiver's location of visible satellites though that is less necessary in newer GPS product hardware. Health data for a satellite is manipulated during programming; satellites are designated unhealthy when their orbits are being corrected, then designated healthy again.

GPS satellites transmit Coarse/Acquisition (C/A) code that is available freely to the public and is a 1,023 chip pseudorandom (PRN) code at 1.023 million chips/sec so that it repeats every millisecond; each satellite has its own unique C/A code to enable its separate identification and signal reception from other satellites at the same frequency. GPS satellites also transmit Precise (P) code, a 10.23 megachip/sec PRN code which is usually encrypted e.g. by the Y-code (generating the P(Y) code), repeated only every week, and reserved for military application. Encryption foils spoofing which can make civilian data unreliable.

Errors can arise from several sources. Ionospheric effects introduce ±5-meter error. Ephemeris effects introduce ±2.5-meter error. Satellite clock errors effects introduce ±2-meter error. Multipath distortion introduces ±1-meter error, as do numerical errors. Tropospheric effects introduce ±0.5-meter error. Other effects such as relativity, Sagnac distortion, and other sources can give rise to additional small errors. Autonomous civilian GPS horizontal position fixes are typically accurate to about 15 meters (50 feet), whereas high frequency P(Y) signal results in an accuracy that is about one order of magnitude better. When it is turned on, a currently disable feature in GPS known as Selective Availability (SA) introduced random errors of up to about 10 meters horizontally and 30 meters vertically to the C/A signals. Interference can also arise from natural sources, solar flares, metallic features in windshields, malfunctioning television preamplifier, etc., can also result in error or signal weakening. Some of these errors are minimized by resolving the uncertainty in phase differences in the signal, such as in Carrier-Phase Enhancement (CPGPS). Another approach resolves the cycle numbers in which signal is transmitted and received, by means of differential GPS (DGPS) correction data, as in Relative Kinematic Positioning (RKP) statistically with Real-Time Kinematic Positioning (RTKP).

GNSS Augmentation incorporates external information to improve the accuracy, availability, or reliability of the satellite navigational system. Several such systems exist. Some correct for sources of error such as clock drift, ephemeris, or ionospheric delay. Others measure the history of the degree of error in the signal. A third type of augmentation provides supplemental navigational or vehicle data for calculations. Augmentation systems include the Wide Area Augmentation System, the European EGNOS, the MSAS, Differential GPS, and Inertial Navigational Systems.

NAVSTAR GPS typically requires at least four satellites to calculate its position in each of the x, y, z, and time (t) dimensions. Computations of distance are based on the signal speed (speed of light for signal in space, slightly less for signal traveling through the ionosphere). Fewer satellites are needed when one variable (e.g., altitude) is already known, and or when various approximations are used, such as satellite signal Doppler shift, last known position, dead reckoning, inertial navigation, etc.). The satellite signal in addition to including the time of transmission also reports parameters for calculating the satellite's location (the ephemeris) and the general system health (the almanac). A GPS receiver can determine location, speed, direction, and time. NAVSTAR GPS is operated by the U.S. Department of Defense.

Assisted GPS (A-GPS or aGPS) was introduced to enhance the performance of conventional GPS for cell phones; the development of A-GPS was expedited in response to the the U.S. Federal Commerce Commission's E911 mandate making the position of a cell phone available to emergency call dispatchers. Conventional GPS had reliability issues under poor signal conditions, such as when reflection of signal from tall buildings or atmospheric effects led to multipath, in which satellite signals arrived at the device by more than one path, as for an echo. Multipath can cause a stationary receiver's output to indicate as if it were randomly jumping about or creeping. When the unit is moving the jumping or creeping is hidden, but multipath still degrades the displayed accuracy. The weakening of signal indoors or under cover of a canopy of trees can also be problematic, though some newer receivers are far better under these conditions. Also, when a GPS unit is powered up in multipath and or weak signal conditions, some non-A-GPS units may not be able to download the almanac and ephemeris information from the GPS satellites, rendering them unable to function until a clear signal can be received continuously for up to one minute.

An A-GPS receiver addresses these problems in several ways using an Assistance Server by locating a phone approximately by its location in a cellular network, by using the server's computational power to compare fragmentary cell phone signals with direct satellite signal, by supplying orbital data for GPS satellites to the cell phone to enable locking on to the satellite signal, and by employing more complete data about ionospheric conditions than the cell phone has to improve precision in position calculation. Some A-GPS solutions require an active connection to a cell phone network or other data network, other A-GPS solutions do not. Because the assistance server can do most of the computational work, the amount of CPU and programming required in a GPS phone can be quite small.

High Sensitivity GPS is similar to A-GPS, addressing some of the same issues that do not require additional infrastructure. However unlike some forms of A-GPS, High Sensitivity GPS cannot provide instant fixes on satellite positions when the phone has been off for some time.

Enhanced GPS (or eGPS) is a technology designed for mobile phones on GSM/W-CDMA networks, to augment GPS signals to deliver faster location fixes, better reception of weak signal, lower cost implementations and reduced power and processing requirements. It is being developed by CSR in partnership with Motorola with aspirations for an open industry forum, and exploits data from cellular networks. E-GPS combines CSR's “Matrix” technology to locate the user instantly to 100 meter accuracy based on cell tower information. CSR's “Fine Time Aiding” then guides the device search for a GPS signal, to acquire satellite data within seconds. This is said to be equivalent to 6 dB more sensitivity than achieved by any GPS hardware correlator in the terminal. E-GPS technologies are due to be released in 2008 and are said to be superior to A-GPS. Other use of GPS for monitoring includes the following.

U.S. Pat. No. 6,650,999 to Brust et al. teaches a navigation system carried in a mobile terminal by a driver for finding his or her car upon returning to a parking lot; the information concerning the parked car can also be stored in a remote intermediary memory to which the mobile terminal has access.

U.S. Pat. No. 5,418,537 issued to Bird discloses location of missing vehicles by means of installed GPS antenna, signal receiver/processor, paging responder, cellular telephone with associated antenna, and a controller/modem. Vehicles that remain un-found are paged from a service center to interrogate the GPS receiver/processor for the vehicle's present location.

U.S. Pat. App. Pub. No. 2006/0161345 A1 to Mishima et al. claims a vehicle load control system in which information on the cargo loading condition of a moving vehicle is combined with position information from a GPS and is communicated to a control center.

U.S. Pat. App. Pub. No. 2005/0197755 A1 to Knowlton et al. discloses a method to determine the position and orientation of work machines such as excavators, shovels and backhoes by two- and three-dimensional GPS in combination with inertial sensors to calculate pitch and roll from linear accelerations.

Laid-Open German Pat. App. Pub. No. DE 199 38 951 A1 to Trinkel (Deutsche Telekom AG) discloses a vehicle-finding device, including a GPS receiver and an antenna for the same, a device for computing the direction and or distance to the vehicle, and a device for acoustic, optical and or sensor-motor output especially of the direction and or distance. The device as shown is in the form of a casing for the head of a car key.

In one embodiment of the present invention the NSBD receives navigational information from any of the above-described current navigational guidance systems. In a further embodiment of the invention the NSBD receives navigational information from a GNSS. In a particular embodiment of the invention the NSBD receives navigational information from a GNSS-1 system. In another embodiment of the invention the NSBD receives navigational information from a GNSS-2 system. In yet another embodiment of the invention the NSBD receives navigational information from a ground-based station. In still another embodiment of the invention the NSBD receives navigational information from an aquatic-based station. In a further embodiment of the invention the NSBD receives navigational data from a GPS satellite. In another embodiment the NSBD receives navigational data from an A-GPS transmitter.

### Navigation System Hardware for Receivers

Typical of current GNSS user hardware are GPS units, for which the receiver includes the following:
an antenna;
receiver-processors;
a highly stable clock such as a crystal oscillator;
optionally an information display for the user;
between 12 and 20 channels in contemporary models, corresponding to the number of satellites that they can monitor simultaneously;
optionally an input for differential locations, such as the RTCM SC-104 format, internal DGPS format, or Wide Area Augmentation System Receiver;
hardware for relaying position data to a PC or other device, such as by the US-based National Marine Electronics Association (NMEA) 0183 or 2000 protocol, or such as the SiRF or MTK protocol; and
optionally an interface for other device such as a serial connection, USB or Bluetooth.

GPS receivers are small enough to fit into phones and watches, and for instance a SiRFstar III receiver and integrated antenna from the Antenova company (UK) has dimensions 49×9×4 mm, which is about the size of a small, wafer-thin computer keyboard.

### Signal Collection and Processing

Navigational systems have common tasks and requirements in signal collection and processing, which are exemplified by the GPS system. There a receiver selects a C/A code by PRN number for monitoring, based on its previously acquired almanac information. The receiver detects each satellite's signal, and identifies it by its distinct C/A code pattern. Then it reproduces the C/A sequence referenced to its local clock at the same as the satellite transmission, and computes the offset to the local clock on the basis of the 50 Hz (20 ms) transmission rate and the alignment of the PRN code. This yields a time-of-flight and corresponding distance to the satellite.

With this information for a plurality of satellites, the receiver uses one of several mathematical techniques to solve for x, y, z and t. For example the receiver may use iterative methods to identify the location for intercepts of pseudo-ranges (the pseudo-ranges are represented as curved envelopes of signal) as a function of weighted averages of positions and clock offsets. The calculated location is then translated into a specific coordinate system such as latitude/longitude using the WGS 84 geodetic datum or a country-specific system.

### Accelerometers

An accelerometer is a device for measuring reaction forces that are generated by acceleration and or gravity; accelerometers designed for measuring gravity alone are known as gravimeters. Accelerometers can be used to sense inclination, vibration, and shock. Both acceleration and gravity are typically measured in terms of g-force (m/s 2), where 1 g=ca. 9.8 m/s² (ca. 32 ft/s²). Single- and multi-axis models are available to detect magnitude and direction of the acceleration as a vector quantity. Under Einstein's equivalence principle the effects of gravity and acceleration are indistinguishable, thus acceleration can be measured alone only by subtracting local gravity from an accelerometer's output of raw data, otherwise an accelerometer at rest on the earth's surface will measure 1 g along the vertical axis. Horizontally, the device yields acceleration directly, but the device's output will zero during free fall in space (a relative vacuum), when the acceleration is identical to that of gravity. For a free fall in earth's atmosphere the device zeros only when terminal velocity (1 g) is reached, due to drag forces arising from air resistance. For inertial navigation systems, vertical corrections for gravity are usually made automatically, e.g., by calibrating the device while at rest. For the sake of reference, it is noted here that Formula One race car drivers usually experience 5 g while braking, 2 g while accelerating, and 4 to 6 g while cornering, and that most roller coasters do not exceed 3 g by much but a few are twice that.

In recent times accelerometers are commonly very simple micro electromechanical systems MEMS. In a common format they are little more than a cantilever beam with a proof mass (also called a seismic mass) and some type of deflection-sensing circuitry for analog or digital measurements. Under the influence of gravity or acceleration the proof mass deflects from its neutral position. Another type of MEMS-based accelerometer has a small heater at the bottom of a very small dome; the heater heats the air, which subsequently rises inside the dome. A thermocouple on the dome determines where the heated air migration to the dome and the deflection off the center is a measure of the acceleration applied to the sensor.

In a common application, accelerometers are used to calculate the degree of vehicle acceleration and deceleration. In an automobile that enables performance evaluation of both the engine/drive train and braking systems. Common ranges for that purpose include 0-60 mph, 60-0 mph and ¼ mile times, such as in wireless dashboard-mounted devices from Tazzo Motorsports and G-Tech. Accelerometers are also used in flight, for instance to detect apogee in rocketry. A combination of three accelerometers, or two accelerometers and a gyroscope, are also used in aircraft inertial guidance systems.

In more mundane commercial applications accelerometers have been used to measure vibration on vehicles, work machines, buildings, process control systems and safety installations. For instance, MEMS accelerometers are used in automotive airbag deployment systems; their widespread use in these systems has driven down the cost of such accelerometers dramatically. Accelerometers have also been used scientifically to measure seismic activity, inclination, machine vibration, dynamic distance and speed with or without the influence of gravity.

In recent times accelerometers have found use in enhanced measurements of user motion. For instance, accelerometers have been used in step counting (e.g., like a pedometer); thus Nike, Polar, Nokia and others have sold sports watches in which accelerometers help determine the speed and distance of a runner wearing such a watch. The Wii remote game console contains three accelerometers to sense three dimensions of movement and tilt to complement its pointer functionality, facilitating realistic interaction between a virtual avatar and manual movements of the user during sport-like games. The PlayStation 3 and SIXAXIS game consoles also use accelerometers. Zoll's AED Plus uses CPR-D-padz, which contain an accelerometer to measure the depth of chest compressions in cardiopulmonary rescue efforts in the wake of a heart attack or other distress to the heart.

Recent developments also include the use of accelerometers in digital interface control. Since 2005 Apple's laptops have featured an accelerometer known as Sudden Motion Sensor to protect against hard disk crashes in the event of a shock. Smartphones and personal digital assistants (such as Apple's iPhone and iPod Touch and the Nokia N95) contain accelerometers for user interface control, e.g., switching between portrait and landscape modes, and for recognizing other tilting of the device. Nokia and Sony Erickson also employs accelerometers to detect tapping or shaking, for purposes of toggling features on a consumer electronic device.

Examples of various types of accelerometers and some commercial sources for them are shown below. Single-axis, dual-axis, and triple-axis models exist to measure acceleration as a vector quantity or just one or more of its components. In addition, MEMS accelerometers are available in a wide variety of measuring ranges, even to thousands of g's.

Accelerometer data logger—Reference LLC

Bulk Micromachined Capacitive—VTI Technologies, Colibrys

Bulk Micromachined Piezo Resistive

Capacitive Spring Mass Based—Rieker Inc

DC Response—PCB Piezotronics

Electromechanical Servo (Servo Force Balance)

High Gravity—Connection Technology Center

High Temperature—PCB Piezotronics, Connection Technology Center

Laser accelerometer

4-20 mA Loop Power—PCB Piezotronics, Connection Technology Center

Low Frequency—PCB Piezotronics, Connection Technology Center

Magnetic induction

Modally Tuned Impact Hammers—PCB Piezotronics, IMI Sensors

Null-balance

Optical

Pendulating Integrating Gyroscopic Accelerometer (PIGA).

Piezo-film or piezoelectric sensor -PCB Piezotronics, IMI Sensors

Resonance

Seat Pad Accelerometers—PCB Piezotronics, Larson Davis

Shear Mode Accelerometer—PCB Piezotronics, IMI Sensors, Connection Technology Center

Strain gauge—PCB Piezotronics

Surface acoustic wave (SAW)

Surface Micromachined Capacitive (MEMS)—Analog Devices, Freescale, Honeywell, PCB

Piezotronics, Systron Donner Inertial (BEI)

Thermal (submicrometer CMOS process)—MEMSIC

Triaxial—PCB Piezotronics, Connection Technology Center

Additional sources of suitable acceleration switches for use with the present device include the following: Select Controls, Inc. (Bohemia, N.Y.); Inertia Switch, Inc. (Orangeburg, N.Y.); Aerodyne Controls, A Circor International Company (Ronkonkoma, N.Y.); Honeywell Sensing and Control (Golden Valley, Minn.); Measurement Specialties, Inc. (Hampton, Va.); Masline Electronics, Inc. (Rochester, N.Y.); Allied International (Bedford Hills, N.Y.); Jo-Kell, Inc. (Chesapeake, Va.); D'Ambrogi Co. (Dallas, Tex.); Impact Register, Inc. (Largo, Fla.); Hubbell Industrial Controls, Inc. (Archdale, N.C.); Comus International (Clifton, N.J.); and Milli-Switch Corp. (Bridgeport, Pa.).

### Inertial Navigation Systems

An inertial navigation system (INS) uses a computer and motion sensors—particularly a combination of accelerometers and optionally a device such as gyroscope—to continuously track the position, orientation, and velocity (direction and speed of movement) of a vehicle without the need for external references. Other names for these and related devices include inertial guidance system, inertial reference platform, and similar appellations. The initial position and velocity is provided from another source such as a human operator, GPS satellite receiver, etc., and thereafter computes its own updated position and velocity based on data from its motion sensors. The advantage of an INS is that it requires no external references when determining its position, orientation, or velocity after receiving the initial external data. Among other benefits, it is immune to jamming of radio waves. It can also continue to recognize its own location even when radio contact is broken off, such as inside a canyon or an airport terminal.

An INS can detect a change in its velocity, orientation (rotation about an axis) and geographic direction (vector) by measuring the linear and angular accelerations. The orientation is determined by gyroscopes, which measure the angular velocity of the system in the inertial reference frame much as a passenger can feel the tilt of a plane in flight. Accelerometers measure the linear acceleration of the system in the inertial reference frame, but only in directions that can be measured relative to the moving system, much as passengers may experiences pressure forcing them into their seats during take-off. By tracking a combination of the linear and angular acceleration, the change relative to the inertial reference frame may be calculated. Integrating the inertial accelerations with the original velocity as the initial condition in appropriate kinematic equations yields the inertial velocities of the system. Integrating again with the original position as the initial condition yields the inertial position. INS was originally developed for rockets and employed rudimentary gyroscopes, but today is commonly used in commercial aircraft and other transportation vehicles.

All INSs suffer from integration drift that arises from the aggregation of small errors in measurement that is inherent in every open loop control system. The inaccuracy of a high-quality INS is normally less than 0.6 nautical miles per hour in position, tenths of a degree per hour in orientation. Output errors may be an order of magnitude greater for INS alone than for GPS alone. Combining INS output data with output data from another navigation system such as a GPS system can minimize and stabilize drift in position and velocity computations for either or both systems. The location determined by a GPS system can be updated every half-minute, thus when GPS signal is accessible a logic circuit can essentially eliminates the drift arising from INS. In complementary fashion, the INS provides ongoing position information when the observer is in a location where GPS signals cannot be received. The inertial system provides short-term data, while the satellite system corrects accumulated errors of the inertial system. In fact, INS is now usually combined with satellite navigation systems through a digital filtering system, such as by utilizing control theory or Kalman filtering. The INS can also be re-calibrated during terrestrial use by holding it at a fixed location at zero velocity.

INSs have both angular and linear accelerometers for changes in position; some include a gyroscopic element for maintaining an absolute angular reference. Angular accelerometers measure how the vehicle is rotating in space. Using aircraft guidance systems as an example, generally, there is at least one sensor for each of the three axes: pitch (nose up and down), yaw (nose left and right) and roll (clockwise or counter-clockwise from the cockpit). There is typically a linear accelerometers to measure motion in space along each of three axes (vertical, lateral, and direction of travel). A computer continually updates the vehicle's current position. First, for each of the six degrees of freedom (x,y,z and θₓ, θ_{y}, and θ_{z}), it integrates the sensed amount of acceleration over time to compute the current velocity. Then it integrates the velocity to compute the current position. In addition, an inertial guidance system that will operate near the earth's surface must incorporate Schuler tuning so its platform will continue pointing towards the earth's center during movement of the vessel.

The relative cost and complexity of INS designs affect the choice of which systems are most practical for use in the current invention, however with the ongoing deflation of prices for electronic devices various INS designs are increasingly practical and some are already within an appropriate range. Illustrative examples of INS systems in the current art that are technically suitable for use with the invention include the following.
Gimballed gyrostabilized platforms have linear accelerometers on a gimbaled gyrostabilized platform. The gimbals are a set of three rings, each with a pair of bearings initially at right angles to let the platform twist about any rotational axis. Usually the platform has two gyroscopes at right angles so as to cancel gyroscopic precession, the tendency of a gyroscope to twist at right angles to an input force. This system allows a vehicle's roll, pitch, and yaw angles to be measured directly at the bearings of the gimbals. Relatively simple electronic circuits can be used to add up the linear accelerations, because the directions of the linear accelerometers do not change. Expense, wear, potential to jam, and gimbal lock are among the drawbacks of these systems.
Fluid-suspended gyrostabilized platforms use fluid (i.e., helium or oil) bearings or a flotation chamber to mount a gyrostabilized platform, usually there are four bearing pads in a tetrahedral arrangement in spherical shell. These systems can have very high precisions (e.g. Advanced Inertial Reference Sphere), and like all gyrostabilized platforms, they run well with relatively slow, low-power computers. Low end systems use bar codes to sense orientation, and may be powered by a solar cell or single transformer. High-end systems employ angular sensors composed of a strip of transformer coils on a printed circuit board, in combination with transformers outside the sphere, to measure (induction-based) changes in magnetic field associated with movement.
Strapdown systems have sensors strapped to the vehicle, which eliminates gimbal lock, removes the need for some calibrations, minimizes the computing hardware requirements, and increases the reliability by eliminating some of the moving parts. Angular rate sensors called “rate gyros” are employed. Whereas gimballed systems could usually do well with update rates of 50 to 60 updates per second, strapdown systems normally update about 2000 times per second in order to keep the maximum angular measurement within a practical range for real rate gyros: about 4 milliradians. Most rate gyros are now laser interferometers. Maintaining precision in the updating algorithms (“direction cosines” or “quaternions”) requires digital electronics, but such computers are now so inexpensive and fast that rate gyro systems are in practical use and mass-produced.
Motion-based alignment infer orientation from position history, as in GPS for cars and aircraft, where the velocity vector usually implies the orientation of the vehicle body. Honeywell's Align in Motion (Doug Weed, et al., “GPS Align in Motion of Civilian Strapdown INS,” Honeywell Commercial Aviation Products) is an FAA-certified process in which the initialization occurs while the aircraft is moving, in the air or on the ground; it uses GPS and an inertial reasonableness test (allowing commercial data integrity requirements to be met) and recovers pure INS performance equivalent to stationary align procedures for civilian flight times up to 18 hours. It avoids the need for gyroscope batteries on aircraft.
Vibrating gyros are used in inexpensive navigation systems as for automobiles, may use a vibrating structure gyroscope to detect changes in heading, and the odometer pickup to measure distance covered along the vehicle's track. This type of system is much less accurate than a higher-end INS, but is adequate for typical automobile applications in which GPS is the primary navigation system, and dead reckoning is needed only to fill gaps in GPS coverage when buildings or terrain block the satellite signals.
Hemispherical Resonator Gyros (HRG or “Brandy Snifter Gyros”) employ a standing wave induced in a hollow globular resonant cavity (i.e. something like a brandy snifter); composed of piezoelectric materials such as quarts; when the cavity is tilted the waves tend to continue oscillating in the original plane of motion, thereby allowing measurement of the angle between the original and turned plane of motion. The electrodes to start and sense the waves are evaporated directly onto the quartz. This system has almost no moving parts, and is very accurate, though at present the cost of the precision ground and polished hollow quartz spheres limits the scope of practical use. The classic system is the Delco 130Y HRG, developed about 1986.
Quartz rate sensors are usually integrated on silicon chips. Each of these sensors has two mass-balanced quartz tuning forks, arranged “handle-to-handle” so forces cancel. Aluminum electrodes evaporated onto the forks and the underlying chip both drive and sense the motion. The system is inexpensive, and the dimensional stability of quarts makes the system accurate. As the forks are twisted about the axis of the handle, the tines' vibration tends to continue in the same plane of motion, which is resisted by electrostatic forces from electrodes under the tines. By measuring the difference in capacitance between the two tines of a fork, the system determines the rate of angular motion. Current non-military versions include small solid state sensors that can measure human body movements; they have no moving parts, and weigh about 50 grams. Solid state devices such as these are used to stabilize images taken with small cameras or camcorders, can be extremely small (5 mm) and are built with MEMS (Microelectromechanical Systems) technologies.
Magnetohydrodynamic (MHD) sensors are used to measure angular velocities; their accuracy improves with the size of the sensor.
Laser gyros eliminate the bearings in gyroscopes, and thus avoid most disadvantages of precision machining and moving parts. A laser gyro splits a beam of laser light into two beams in opposite directions through narrow channels in a closed optical circular path around the perimeter of a triangular block of temperature-stable cervit glass block with reflecting mirrors placed in each corner. When the gyro rotates at some angular rate, the distance traveled by each beam becomes different—the shorter path being opposite to the rotation. The phase shift between the two beams is measured by an interferometer, and is proportional to the rate of rotation (the Sagnac effect). In practice, at low rotation rates the output frequency can drop to zero (i.e., no interference detected) after the result of “back scattering,” causing the beams to synchronize and lock together, which is known as a “lock-in”, or “laser-lock.” To unlock counter-rotating light beams, laser gyros either have independent light paths for the two directions (usually in fiber optic gyros), or the laser gyro is mounted on a piezo-electric dither motor that rapidly vibrates the ring back and forth about its input axis through the lock-in region to decouple the waves. The shaker design is accurate because both light beams use exactly the same path, but does contain moving parts though they do not move far.
Pendular accelerometers have a mass which can move only in-line with a spring to which it is attached. For an open-loop system, acceleration along the axis of the spring causes a mass to deflect in the other direction, and the offset distance is measured. The acceleration is derived from the values of deflection distance, mass, and spring constant. The system must also be damped to avoid oscillation. A closed-loop accelerometer achieves higher performance by using a feedback loop to cancel the deflection, thus keeping the mass nearly stationary. Whenever the closed-loop mass deflects, the feedback loop causes an electric coil to apply an equally negative force on the mass, canceling the motion and greatly reducing the non-linearities of the spring and damping system. Acceleration is derived from the amount of negative force applied. In addition, this accelerometer provides for increased bandwidth past the natural frequency of the sensing element. Both types of accelerometers have been manufactured as integrated micromachines on silicon chips.

Commercial sources for inertial navigation systems and or their components include the following.
AeroSpy Sense & Avoid Technology GmbH, Austria
Applanix—A Trimble Company, Canada
Crossbow Technology Inc., USA
Dewetron, Austria
Deutsche Montan Technologie GmbH, Germany
Flexit, Sweden—borehole positioning systems.
Honeywell Inc., USA
IGI, Germany
iMAR Navigation GmbH, Germany—European solutions for global industrial and defense applications with all types of inertial sensor technology
InterSense, USA—miniature inertial sensors and hybrid tracking systems.
iXSea, France
Kearfott Guidance & Navigation Corporation, USA
Kongsberg Maritime, Norway
Microbotics Inc, USA—GPS-Aided INS
MicroStrain—inclinometers and orientation sensors
Nec-Tokin, Japan—miniature ceramic sensors
Navigation Systems index Northrop Grumman, USA
   Litef, Germany (a division of Northrop Grumman, USA)
   Northrop Grumman Italia, Italy (a division of Northrop Grumman, USA)
   Sperry Marine (a division of Northrop Grumman, USA)
Sagem, France
SEG, Germany
Systron Donner Inertial, USA (owned by Schneider Electric)
TUBITAK—SAGE, Turkey—Integrated Inertial Navigation Systems
Technaid, Spain—Inertial Measurement Systems
TRX Systems, Inc—Integrated Inertial Navigation Systems
U.S. Dynamics Corporation, USA
Verhaert, Belgium
Xsens, Netherlands—miniature solid state sensors
Invensense—silicon chip sensors

### Critical Acceleration and Deceleration Thresholds

Aircraft vary widely in the amount of g-force they produce during take-off and landing—for takeoff in particular the critical speeds depend on the size and weight of the plane—however common ranges for large passenger jets provide a useful point of reference. From a standing start large Boeing aircraft may approach velocities of 180 m.p.h. over a period of about 40 seconds or more before lifting off, typically on a runway of 8,000 to 10,000 feet in length. If the acceleration is uniform during the pre-liftoff phase, this corresponds to acceleration of about 2 M/s2, or about 0.2 g. In reality acceleration rates are never completely uniform for take-off, so the 0.2 g value represents one point in the actual range of acceleration during the event. Landing involves decelerating from a substantially higher velocity than the lift-off velocity (which is distinct from but of comparable magnitude to the stall velocity) and over a somewhat shorter runway distance: a typical range for deceleration of passenger aircraft is about 0.7 to 1.5 g. FAA studies find that lateral acceleration of passenger planes in the air rarely exceeds 0.2 g (http://www.ntsb.gov/recs/letters/2003/A03_{—}41_{—}44.pdf, p. 2, also at footnote 5). Certain other aircraft are more nimble on the runway than the Boeing passenger craft, these include a recent large Airbus model as well as commuter jets, yet the lower g-forces observed for passenger flights in the Boeing aircraft can still suffice as a basis for accelerometry-based toggles even in the nimbler vessels. The difference in g-forces between take-off and landing also provides one basis for distinguishing between the two events by accelerometry.

Turbulence can also give rise to g-forces during a flight, and in the simplest case an accelerometer toggle would be unable to distinguish between a landing and in-flight turbulence. However the g-forces from turbulence tend to have a much shorter duration and much less uniformity in acceleration changes than those at lift-off and landing, thus acceleration-based recognition of lift-off and landing can distinguish runway activity from ordinary turbulence when duration and relative homogeneity are part of the detection algorithm. In addition, where the accelerometers are used in combination with an algorithm that identifies the orientation of an aircraft there is a further basis for distinguishing turbulence, slipping, or other in-flight phenomena from runway events. For instance, although baggage may be stowed in any orientation in a cargo hold, even upside down, in one embodiment accelerometers associated with an NSBD are used to recognize the orientation of an aircraft, for instance by identifying the direction of the gravity field before lift-off and by identifying the direction of the nose of the plane by the direction of g-forces during takeoff, factoring out gravity. Having identified the orientation of an aircraft, the algorithm can then screen for only those component vectors of positive or negative acceleration that correspond strictly to the forward motion of the aircraft.

These recognition features in accelerometry-based toggling schemes further enable the present invention because they allow an algorithm to distinguish aircraft events from mundane handling and from motion in an automobile. For instance, baggage handling seldom involves smooth acceleration increases for tens of seconds. Likewise, although automobiles can easily accelerate from 0 to 60 mph in 13 seconds, which represents a constant acceleration rate of about 0.20 g and thus is at the same g-force as a typical take-off for a Boeing jet, the duration of the acceleration is much shorter than that of a passenger aircraft take-off as evidenced by the fact that the automobile acceleration takes place over a distance of no more than a few hundred feet. So, for instance, by setting an accelerometry-based toggle to a 30-second timing and smooth acceleration changes for triggering (de)activation, the NSBD output signal would not be turned on or off while driving to or from an airport or placing the bag on a moving belt, and the beacon mechanism will not be disabled during a time that its position is intended to be locatable.

Re-activation of the NSBD's transmission capability can also be delayed after sustained deceleration is confirmed, e.g., a delay of seconds or minutes may be imposed in a toggle-on circuit in order to ensure the plane is at rest and the NSBD is compliant with FAA requirements before the transmissions resume.

The same paradigm that provides the ability to toggle the NSBD upon takeoff and landing automatically also provide the capacity to prevent such toggling. For instance, a NSBD transmitter may be turned off manually at the time baggage is checked at an airline counter or carried onto a plane. One or more accelerometers in a history circuit can then serve as a switch that prevents the transmitter from responding to remote signals that would turn it on again before the plane lands. An official override signal might be used to reactivate the device in cases where the luggage never actually leaves the airport. In another embodiment an override signal is received from an aircraft's own accelerometer(s) when a threshold level of acceleration or deceleration or velocity is reached, thus enabling the NSBD to be turned off or on automatically in compliance with a particular airline's signal protocols.

More extreme g-force ranges can also be used for the detection specifications. Recently space flight and other high-performance flight has begun to become accessible to ordinary consumers who have the wherewithal to pay for the trip. For such trips g-forces can reach as high as 4 g or more during the launch, and may be in the range of 6 g or more upon re-entry to the atmosphere.

In one embodiment of the present invention the NSBD comprises an accelerometer that can detect a force that is in the range of 0.1 g to 10 g. In another embodiment the NSBD comprises an accelerometer that can detect a force that is in the range of 0.5 g to 5 g. In an additional embodiment the NSBD comprises an accelerometer that can detect a force that is in the range of 0.7 g to 4 g. In a particular embodiment the NSBD comprises an accelerometer that can detect a force that is in the range of 0.7 to 1.5 g. In a further embodiment the NSBD comprises an accelerometer that can detect a force that is in the range of 0.05 g to 0.5 g. In yet another embodiment the NSBD comprises an accelerometer that can detect a force that is in the range of 0.6 g. In still another embodiment the NSBD comprises an accelerometer that can detect a force that is in the range of 0.2 g. In a particular embodiment the NSBD comprises a plurality of accelerometers whose detection ranges are selected from one or more of these ranges.

In one embodiment of the present invention the NSBD comprises a history circuit that itself comprises an accelerometer. In a particular embodiment the NSBD comprises a history circuit that itself comprises one or more accelerometers that can detect a force that is in the ranges specified in the previous paragraph. In an additional embodiment the NSBD comprises a history circuit that can detect g-force profiles for takeoff and landing of a passenger aircraft. In yet another embodiment the NSBD comprises a history circuit electrically connected to a switch that can toggle the NSBD's transmitter on or off. In a further embodiment the NSBD comprises a history circuit electrically connected to a switch for remote toggling on and or off of the NSBD's transmitter, such that when the history circuit recognizes in-flight status the switch is prevented from toggling the transmitter on. In still another embodiment the NSBD comprises a history circuit electrically connected to a switch for remote toggling on and or off of the NSBD's transmitter, such that when the history circuit recognizes end-of-flight status the switch is allowed to toggle the NSBD's transmitter on. In an additional embodiment the NSBD comprises a history circuit electrically connected to a switch for remote toggling on and or off of the NSBD's transmitter, such that when the history circuit recognizes end-of-flight status the switch is allowed to toggle the NSBD's transmitter on in a time-delayed fashion.

### Critical Velocity Thresholds

Because the commercial air travel industry employs so many sizes and models of aircraft and because different sizes and models vary widely in their respective profiles for acceleration and to a lesser extent deceleration, it is desirable to have a supplementary or alternative threshold physical parameter for toggling the NSBD functions. Velocity is particularly suitable as such a parameter. An INS or other accelerometer-equipped circuit can determine velocity as a combined function of acceleration rate and time, i.e., the velocities are cumulative. Alternatively the velocity can be determined as a function of displacement divided by time, i.e., the velocity is determined by a time average. In the latter case positions determined by a GPS or other GNSS device are compared for two different points of time.

The velocity will typically be selected to distinguish between travel speeds on aircraft and travel speeds for land-based or water-based transport. There are a variety of convenient values from which to choose. 150-180 mph is a typical take-off speed, and 500 mph is a typical high-altitude air cruising speed. Speeds for ground transport vehicles seldom exceed 80 or 90 mph even on highways, and speeds on watercraft and conveyor belts are much lower. Thus for a take-off-based toggling, a value between 80 and 180 mph might be selected for the threshold speed. In particular embodiment a value between 90 and 150 mph would be convenient. In a further embodiment a value between 100 and 140 mph would be selected. In yet another embodiment a value between 110 and 130 mph is selected. In another particular embodiment toggling occurs at about 120 mph. The several ranges just described or similar values can also be used for toggling upon deceleration (i.e., upon landing). Note that the high velocity difference between take-off and landing provides a particularly useful basis for distinguishing between the two events by rate calculations. The velocity may alternatively be designated in the equivalent number of knots.

In additional embodiments, toggling occurs when the velocity is zero following a period of non-zero velocity. This condition models the timing for post-landing activity, taxiing to a stop, and disembarking. In one embodiment, toggling occurs as soon as the measured velocity reaches zero following a period of non-zero velocity. In another particular embodiment, toggling occurs when velocity has been zero for a period of at least 1 minute following a period of non-zero velocity. In another embodiment, toggling occurs when velocity has been zero for a period of at least 2 minutes following a period of non-zero velocity. In a further embodiment, toggling occurs when velocity has been zero for a period of at least 5 minutes following a period of non-zero velocity. In a further embodiment, toggling occurs when velocity has been zero for a period of at least 15 minutes following a period of non-zero velocity. In other embodiments, toggling occurs when velocity has been zero for a period of at least 30 minutes or at least 60 minutes following a period of non-zero velocity.

The time for determining the velocity based on GPS data depends on how many satellites the GPS can draw upon. One study reports that it takes a minute or more to collect the necessary raw data for determining travel velocity when signals from six satellites are available; the collection time is reduced when signals from more satellites are available, but is still significant. (http:H/209.85.215.104/search?q=cache:hzaepRFmyBsJ:math.tut.fi/posgroup/sirola_syrjarinne_io n2002.pdf+GPS,+computation+time&hl=en&ct=clnk&cd=6&gl=us). The collection time does not include the computation time for calculating velocity and position, though computation should be substantially faster than signal processing. It should be borne in mind that GPS signals are sent in 30-second frames, which represent a lower limit for the duration of signal collection using currently available technology and are nearly the duration of runway acceleration time for many take-offs. The GPS computation speed will suffice for determining velocity in a timely way in some preferred embodiments, but in some other preferred embodiments the user may prefer to use a faster collection algorithm.

By contrast, data from an accelerometer can be collected essentially in real time, allowing instantaneous toggling at a predetermined speed. When velocity alone is the criterion for switching, the internal error accrued during the data collection period is generally small enough to be negligible for practical purposes. Data collection error accrual effects are illustrated e.g., if velocity is calculated as

$${\sum }_{i = 1}^{i = n} ( {a}_{i} ) ( {t}_{i} )$$

where aᵢ is a respective acceleration rate, tᵢ is the period of time during which that acceleration rate is applied, and n is the number of acceleration rate phases in the calculation, which may alternatively be performed as an integral calculation, e.g., assuming smooth changes in the acceleration rate.

Note that although the ranges just discussed are useful for flight in particular, analogous ranges can be defined for automotive travel. For instance, luggage may be tracked during transportation on a luggage cart, bus, truck, train, cab, private car or other vehicle, with transmission or other functions optionally turned off in the absence of a query or toggling (on or off) signal, so as to preserve battery life for the NSBD while the luggage is in transit. In this case velocities anywhere in the range from 0 to 90 mph might be used, optionally designated in increments of 1, 2, 3, 5, 10, 15, 20 or 30 mph for convenience. The velocity may alternatively be designated in the equivalent number of knots.

It is useful to be able to toggle an NSBD at will. For instance, airline security protocols sometimes require passengers to switch electronic devices in their carry-on luggage on or off to confirm that they are not hazardous or intended for terrorism. Also, in the event of an automotive collision, particularly a head-on collision, it is possible that an NSBD might toggle off transmission because of detecting a velocity equivalent to that of an aircraft at take-off, and would likely recognize no corresponding “landing” event. Thus in order to use the NSBD again its owner would need to be able to override the autonomous toggle manually or by a counteracting signal.

The threshold velocities may be stipulated and or set by the client, the airline, a governmental body, the vendor who runs the central server, or another party, and can be changed on demand. Also, instead of mph levels or their knot equivalents (where 1 knot=ca. 1.152 mph), convenient rounded demarcations of knots may be used, e.g., optionally designated in increments of 1, 2, 3, 5, 10, 15, 20 or 30 knots for convenience. For example, 150 knots might be designated as the top take-off speed instead of the (slightly higher) 180 mph. Picking threshold levels for toggling based velocity tends to be somewhat arbitrary in any case.

### FAA Regulations On Use of Electronic Devices During Phases of Passenger Flight

It is commonly announced during flights that FAA regulations prohibit the use of Personal Electronic Devices (PEDs) during takeoff or landing; PEDs include CD players, laptop computers, video games, cellular telephones, etc. The rule stated in these announcements is oversimplified. The actual regulations stipulate merely that no electronic devices that cause interference are allowed on airplanes. Some PEDs are in fact allowed, including portable videorecords, hearing aids, heart pacemakers, electric shavers, and “[a]ny other portable electronic device that the [airline] has determined will not cause interference with the navigation or communication system of the aircraft on which it is to be used.” (14 CFR 91.21a). Pilot reports have included anecdotal evidence that alleged instrument malfunction was solved by asking specific passengers in specific portions of the plane to turn off their electronic devices or to move. Yet no studies have conclusively confirmed electromagnetic interference by PEDs, and some observers say that virtually all of the anecdotal interference incidents has been reported from older aircraft, those with minimal shielding, analog controls, and higher susceptibility to all types of interference. Also, some devices, such as laptops, must be stowed during takeoff and landing less because of their transmissions than to prevent them from becoming intra-cabin projectiles during an unsteady takeoff or landing. Other devices, such as Walkman or Discman players, are prohibited during takeoff and landing not necessarily because of electronic interference with instruments, but because they may prevent passengers from hearing the intercom in the event of trouble.

Recently the FAA, at the request of industry and others, reopened earlier studies by the Radio Technical Commission for Aeronautics (RTCA) on ways to manage new technologies. It is expected that industry will support use of cell phones and personal digital assistants for internet activity, though possibly not for voice because of its potential for nuisance in the cabin. (http ://www.airlines.org/operationsandsafety/engineering/EMMC+Portable+Electronic+Devices. htm). The RTCA is a Federal Advisory Committee with over 300 members drawn from U.S. and foreign government, industry and academic organizations, including the FAA.

In lieu of specific federal regulations for PEDs, the major airlines have adopted their own policies, essentially following the recommendations of the RTCA. Thus in-flight use of intentional signal transmitters is currently banned entirely by the airlines apart from health-related exceptions such as pacemakers noted above. Devices that emit no signal are banned during landing and takeoff, but allowed during flight above 10,000 feet altitude. However, luggage losses are a high priority at the FAA and abroad. Moreover, an RTCA task force supports the airlines' transition to navigation by GNSS (http://www.rtca.org/aboutrtca.asp). Thus there are strong prospects for new laws and practices that will make whole or partial accommodation for signals by luggage tracking applications during some phases of flight.

### Transmitting and Reporting.

The NSBD transmitter may transmit by any medium and frequency that is practicable for wireless communication, including by telephony, short wave radio, digital or analog signal, marine band, or other remote telecommunication medium. For transmitting to a central server a telephonic or paging signal is particularly useful. Communications between a client and central server may conveniently employ any practicable medium, wireless or otherwise. This may include telephone calls, wireless text messages, email, postings to a website, and other media.

### Bluetooth™.

In one embodiment of transmission and reporting, when the NSBD comes within 32 foot range of a Bluetooth™ device there is “connection made” allowing automatic notification of the client. In this embodiment, when the NSBD is “ACTIVE/ON” in that range of distance, the user will be able to detect its presence via software applications run to “watch” for the appropriately “named Bluetooth™ device ”. The NSBD will then contact the central server and or the client through the Bluetooth™ device

Bluetooth™ is a wireless communication protocol that uses short range radiofrequency transmissions to connect and synchronous fixed and or mobile electronic devices into wireless personal area networks (PANs), yet with low power consumption. Its specification is based on frequency-hopping spread spectrum technology. The Bluetooth™ specifications are developed and licensed by the Bluetooth™ Special Interest Group (SIG), and involve transceiver microchips in each of the communicating devices. The Bluetooth™ SIG consists of companies in the areas of telecommunication, computing, networking, and consumer electronics. Most Bluetooth™ devices have unique addresses, unique names, can be configured to advertise their presence. Connectable devices for Bluetooth™ include mobile and other telephones, laptops, personal computers, printers, GPS receivers, digital cameras, Blackberry™ devices and video game consoles over a secure, globally unlicensed Industrial, Scientific and Medical (ISM) 2.4 GHz short-range radiofrequency bandwidth. Bluetooth™ is supported on Microsoft™, Mac™, Linux and other platforms

Under current Bluetooth™ technology Class III (1 mW (0 dBm) devices have a range of 3.2 feet (or 1 meter); Class II 2.5mW (4 dBm) devices (i.e. most bluetooth cellphones, headsets and computer peripherals) have a range of 32 feet (or 10 meters); and Class I (100 mW, 20 dBm) devices have a range up to 100 meters. In most cases the effective range of class 2 devices is extended if they connect to a class 1 transceiver, compared to pure class 2 network. This is due to the higher sensitivity and transmission power of Class 1 devices. The transmissions can be farther; Class 2 Bluetooth radios have been extended to 1.78 km (1.08 mile) with directional antennas and signal amplifiers. Transmissions also do not need to be within the line of sight, and if the signal is strong enough can penetrate a wall.

Current data transmission rates are in the range of 1 Mbit/s (version 1.2) or 3 Mbit/s (Version 2.0+EDR), but under improvements proposed by the WiMedia Alliance would increase to 53 to 480 Mbit/s. Currently Wi-Fi technology provides higher throughput and covers greater distances, but requires more expensive hardware and higher power consumption, however unlike Wi-Fi, which is an Ethernet, the Bluetooth™ devices are like a wireless FireWire and can replace more than local area networks and even surpass the universality of USB devices. Bluetooth™ also does not require network addresses or secure permissions, unlike many other networks. Despite considerable public discussion in recent years of the possibility of viruses and worms through Bluetooth™, as of 2008 no major worm or virus has yet materialized, possibly because 10,000 companies in the telecommunications, computing, automotive, music, apparel, industrial automation, and network industries and other companies in the SIG are using and improving the devices and sharing their work on the security measures with each other.

### EXAMPLES

The following illustrative embodiments exemplify various embodiments of the invention as described, but the invention is not so limited.

### Example 1

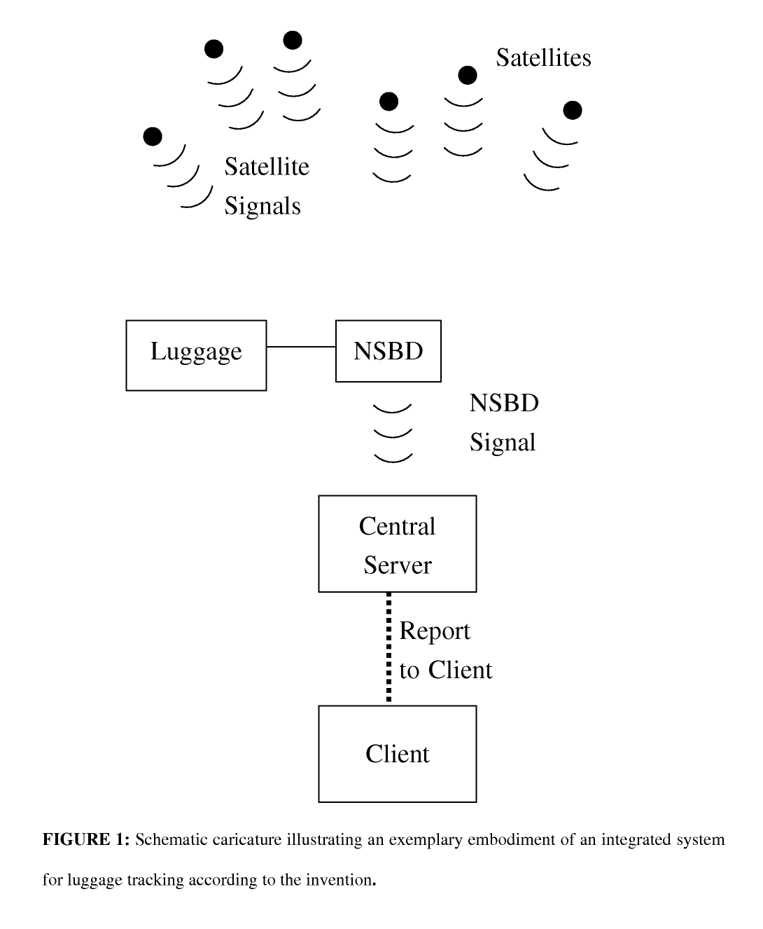

As shown in FIG. 1, a constellation of navigational satellites broadcasts positional information on a steady basis. A luggage item physically attached to an NSBD after receiving those signals broadcasts a signal of its own, which is routed to a central server, and subsequently position information about the NSBD is reported to a client.

### Example 2

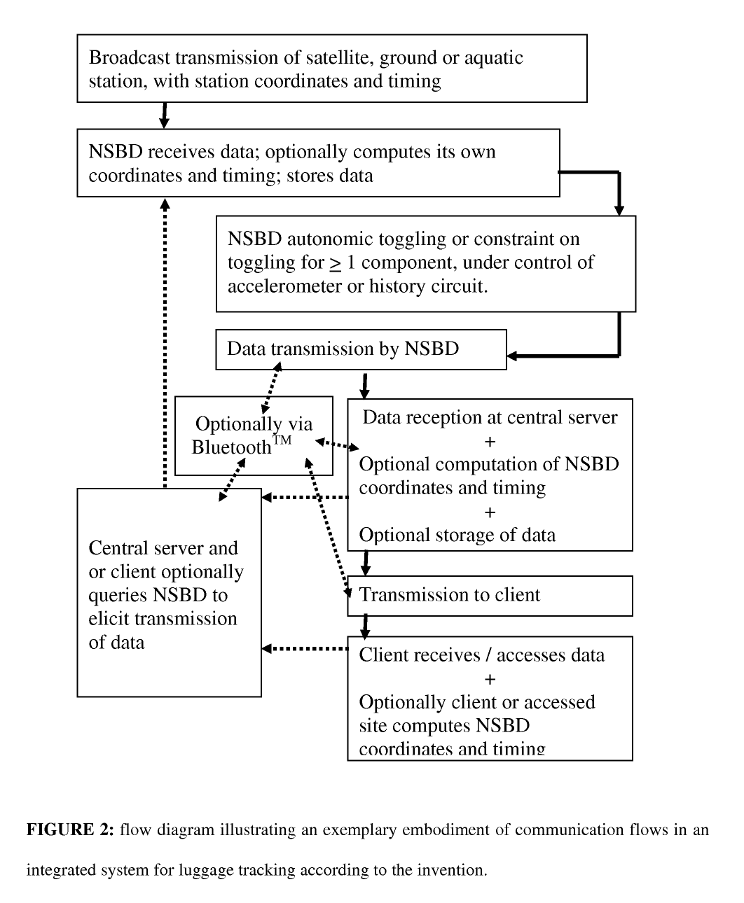

As shown in FIG. 2, broadcast information from navigational stations in space, on land or on water are received, from which—if it is so configured or programmed—the NSBD may optionally compute its own coordinates and timing. A component of the NSBD such as but not limited to the transmitter is governed by autonomic toggling. The autonomic effect is achieved directly by a circuit that closes or opens when an accelerometer detects a critical threshold of g-force, or when a time-based algorithm in combination with an accelerometer detects a critical threshold of velocity. Alternatively the autonomic effect is achieved by a history circuit that closes (or opens) only after a landing is detected, thereby removing constraint against the on mode for a switch. When the switch is on, the NSBD transmitter sends a signal, but to conserve a battery it may be an intermittent or on-demand signal. One reason for shutting down most or all components of the NSBD during a flight is to prevent battery drain, thus for instance it will often be desirable to switch off the receiver. During travel it is often inconvenient to recharge batteries, and generally impossible to recharge batteries remotely for personal electronic devices.

The central server shown in FIG. 2 is optionally operated by a luggage tracking vendor, but may in fact be nothing more than a router or switchboard for sorting and relaying emails or wireless telephone calls. The data received at the central server is redirected to a client, optionally in a further processed form. FIG. 2 illustrates an on-demand function for initiating transmissions from the NSBD. Limiting transmissions to responses to specific queries is another way to limit battery drain in NSBD's.

Optionally, when the NSBD device is “ACTIVE/ON” and within 32 feet of the user/owner of a Bluetooth™ device; the NSBD user will be able to detect its presence via software applications run to “watch” for the appropriately “named Bluetooth™ device ”, and will then be able to communicate with either the server or the NSBD to establish its location. Alternatively, instead of or in addition to the NSBD establishing communications through a Bluetooth™-facilitated personal area network, the client or central server may do so, for instance by means of a cell phone or laptop device in which a microchip provides Bluetooth™ functionality.

### Example 3

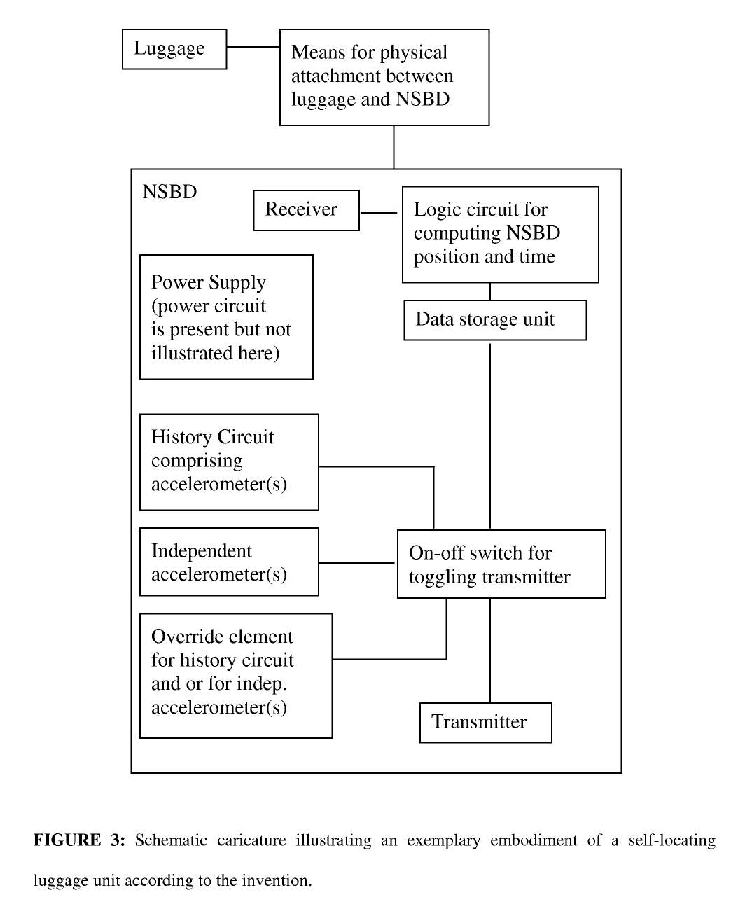

As shown in FIG. 3 the NSBD may be physically attached to the luggage. The NSBD has several components. Here a power supply is shown, but for the sake of highlighting other features the actual circuit for the power is not shown. The receiver is in electrical connection with a logic circuit—in this embodiment the NSBD is configured to compute its own position information and not merely to aggregate information received from satellites or other navigation stations. The data is sent into a memory and then retrieved for transmission. The ability to transmit, however, is governed in this example by independent accelerometer(s) that can toggle a power-down of the transmitter at takeoff and toggle its power-up upon landing. A history circuit augments the independent accelerometers.

When the device settings control transmission ability through the history circuit, the client can turn off the NSBD before boarding a flight, and it cannot be turned on again autonomously or by a wireless electronic query from a remote source until the history circuit detects an end-of-flight event (landing). This feature allows a NSBD to be useful even on a flight where the airline insists that NSBD's be turned off prior to take-off. An alternative way of accomplishing the same result is for a passenger to use a remote control such as an encoded signal from a cell phone to power down the NSBD before flight, allowing a query or the independent accelerometer to serve as the on-toggle when landing conditions are recognized. The combination of an accelerometer and a duration measuring device for deceleration will ensure that turbulence does not reactivate the transmitter, as noted above.

FIG. 3 also illustrates the presence of an override element. In the event that a NSBD transmitter is in the off-mode because of constraints by a history circuit—which could arise from an erroneous detection of a takeoff, or a failure to recognize a landing once takeoff has occurred—no transmission can occur. This will affect the NSBD's ability to self-report the location of associated luggage when it is lost. The override element shown here illustrates a means for decoupling the NSBD's accelerometer and or history circuit in such a case.

### Example 4

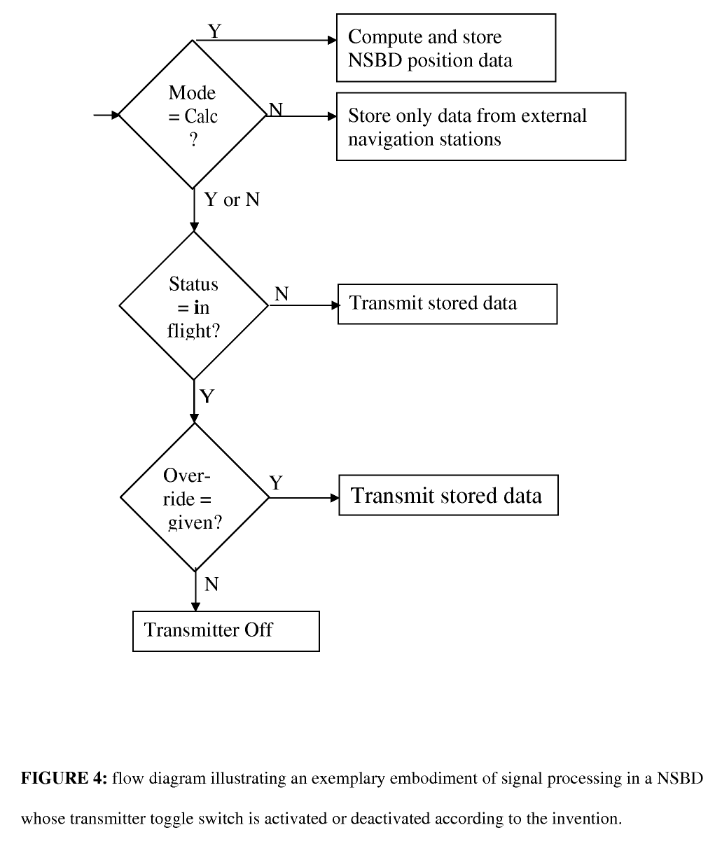

As shown in FIG. 4 the signal for transmission can be processed in a relatively straightforward way. Data from external navigation guidance stations is received, can be stored “as is”, and can be used—if the NSBD is so configured and programmed—to generate a fix on the NSBD's position autonomously. The stored data is not released for transmission unless the circuit finds no in-flight status. Where the circuit does find a designation of in-flight status, the transmitter is kept in the “off” mode unless an override code has been entered (e.g., remotely). For the override case the transmitter will then be restored to its “on” mode.

### Example 5

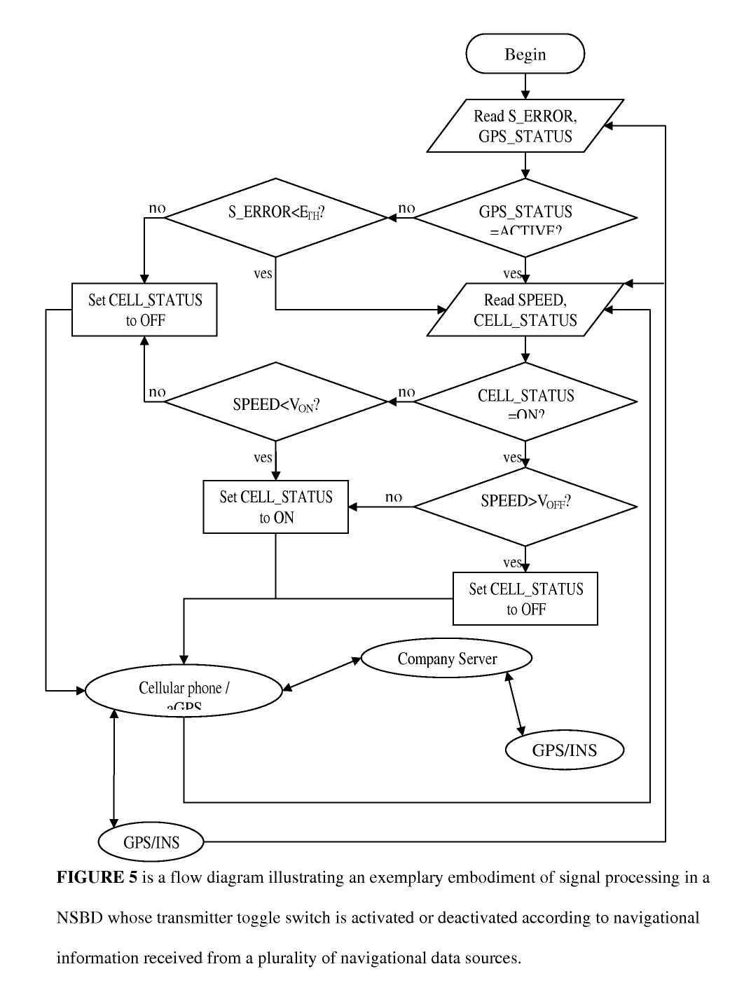

Referring now to FIG. 5, the signal for transmission may be processed from a plurality of navigation data sources in a relatively straightforward way. In one embodiment the high-level requirements of the device are as follows:

1. Determine geographic location

2. Communicate geographic location to user

3. Ensure that transmission capability is disabled when in an aircraft in flight.

In a particular embodiment this is accomplished by coupling assisted GPS (aGPS), cellular telephone technology, and INS or other accelerometer-based circuit with a switching device that toggles transmission capability off when a potential “in-flight” condition is detected.

In this example the NSBD has at least the following four input signals from the aGPS(/INS) module and cellular communication device.
SPEED—the magnitude of the velocity vector determined by the navigation system.
GPS_STATUS—an indicator variable representing whether GPS is capable of determining position without cellular assistance.
S_ERROR—an estimate of the margin of error in measurement of the velocity.
CELL_STATUS—an indicator variable denoting whether transmission capability is on or off.

In this particular embodiment two conditions are specified, as follows.
V_{OFF}—represents the “in-flight” condition in which the computed speed of the device exceeds a pre-defined threshold.
V_{ON}—represents the “ground” condition in which the computed speed of the device is below a pre-defined threshold.
   The “in-flight” status is retained until a reliable speed measurement is obtained below the pre-defined threshold, V_{ON}. The reliability of the speed measurement is determined by evaluating the GPS_STATUS and S_ERROR parameters defined above. The following description illustrates the practice of the embodiment depicted in FIG. 5.

Data from a navigation guidance source is received and evaluated for the margin of error (“S_ERROR”) in the computed velocity is determined. If upon a query the NSBD unit is found to be capable of determining position based on the accessible GPS data alone without assisted GPS (“GPS_STATUS”), the magnitude of the velocity (“SPEED”) is determined from the navigational data.

If GPS_STATUS=ACTIVE, the NSBD will proceed with a calculation of navigation data. By contrast, if the status is not active, the algorithm evaluates whether the computed margin for error in the velocity is below a pre-defined threshold level (S_ERROR<E_{TH}). If the computed level of error exceeds the threshold level, the device does not query—or alternatively sets itself not to receive—navigational information from a cellular telephonic source (“Set CELL_STATUS to OFF”). If the calculated margin for error does not exceed the threshold level, the NSBD will obtain speed information from inertial navigation For active-mode GPS in this embodiment, the logic circuit computes the velocity vector determined through the navigation system. It also determines whether cellular telephonic capability (“CELL_STATUS”) is on or off. If CELL_STATUS is on, the algorithm determines whether the unit is in in-flight condition, i.e., whether the speed exceeds a pre-defined threshold (“V_{OFF}”). If CELL_STATUS is off, the algorithm determines whether the speed falls below another pre-defined threshold (“V_{ON}”). In-flight status is maintained until the speed falls below V_{ON}, where the subscripts ON and OFF refer to conditions for transmitting position from the NSBD.

CELL_STATUS is set to ON once the measured SPEED falls below V_{ON} and remains ON until SPEED exceeds V_{OFF} and or SPEED measurements are deemed unreliable (S_ERROR>E_{TH}). CELL-STATUS is set to OFF if the computed SPEED is greater than or equal to V_{OFF} or the computed S_ERROR is greater than or equal to E_{TH}. The CELL_STATUS mode is communicated to or available upon query to a cellular phone and or assisted GPS (“aGPS”) system which is in communication with a server and optionally a GPS/INS system. The optional GPS/INS system, when present, provides data refinements and corrections to at least one of the server, the cellular phone/aGPS system, and or the NSBD directly. When the GPS/INS system communicates directly to the NSBD, in this embodiment it does so at the step of assessing the error in speed and the status of the GPS capability.

Having described and illustrated specific exemplary embodiments of the invention, it is to be understood that the invention is not limited to those precise embodiments. Various adaptations, modifications, and permutations will occur to persons of ordinary skill in the art without departing from the scope or the spirit of the invention as defined in the appended claims, and are contemplated within the invention.

What is claimed is:

1) A method for tracking the location of a piece of luggage, comprising:
a) placing a navigational system beacon device (NSBD) in close proximity to the piece of luggage;
b) receiving a transmission of position information at a component of the NSBD;
c) storing position information at a component of the NSBD; and
d) transmitting a signal from the NSBD to report position information;
wherein the NSBD's ability to transmit position information is toggled off under the control of an accelerometer when an aircraft containing the piece of luggage takes off and or the NSBD's ability to transmit position information is toggled on under the control of the accelerometer during or after the landing of the aircraft, or wherein the toggling on or off of the NSBD's transmission capacity is constrained by a history circuit comprising an accelerometer.

2) The method of claim 1 wherein the signal reporting position information from the NSBD is received by or relayed to a central server which then reports the location or other position information of the piece of luggage to a client.

3) The method of claim 2 wherein the central server or a device held by the client comprises a means for calculating the location of the luggage as a function of the relative location of the satellites.

4) The method of claim 2 wherein the central server reports the location of the piece of luggage to its owner by means of email or by posting the information to a web site that is accessible to the owner of the piece of luggage.

5) The method of claim 1 wherein the NSBD's close proximity to the piece of luggage is in a manner selected from the group consisting of: as an item within but not affixed to the piece of luggage; affixed to the inside of the piece of luggage; affixed to the outside of the piece of luggage; as an integral component of the piece of luggage; affixed to a luggage dolly, and as an integral component of a luggage dolly.

6) The method of claim 1 wherein the stored position information comprises the relative location of satellites from which the NSBD has received transmitted position information, and or comprises a calculated location of the luggage as a function of the relative location of the satellites.

7) The method of claim 1 wherein the transmitted position information comprises the relative location of satellites from which the NSBD has received transmitted position information, and or comprises a calculated location of the luggage as a function of the relative location of the satellites.

8) The method of claim 1 wherein the NSBD further comprises a means for calculating the location of the luggage as a function of the relative location of the satellites.

9) The method of claim 1 wherein when the ability to transmit information from the NSBD is on, the transmission is periodic and or is generated in response to a transmission from the central server or a client.

10) A method for tracking the location of a piece of luggage, comprising:
a) receiving a transmission of position information from a satellite or ground station at a component of a navigational system beacon device (NSBD) that is in close proximity to a piece of luggage;
b) storing the position information at a component of the NSBD;
c) optionally calculating the position of the luggage based on the position information received from the satellite or ground station, wherein the calculation is performed at a component of the NSBD;
d) transmitting a signal from the NSBD to a central server to report position information, but wherein
i) the NSBD's ability to transmit position information is toggled off under the control of an accelerometer when an aircraft containing the piece of luggage takes off,
ii) the NSBD's ability to transmit position information is toggled on under the control of an accelerometer during or after the landing of the aircraft, and or
iii) the toggling on or off of the NSBD's transmission capacity is constrained by a history circuit comprising an accelerometer;
e) calculating the position of the luggage at a component of the central server based on the position information received by the NSBD from the satellite or ground station, if the position of the luggage had not been calculated at a component of the NSBD; and
f) transmitting position information from the central server to electronically to a client telephone, email address, handheld navigational device or client-accessible web page entry;
wherein position information received at the NSBD is processed to determine the location of the luggage by means of a computation at the NSBD, the central server, the handheld navigational device, the client-accessible web page, or a combination thereof.

11) The method of claim 10 wherein the accelerometer is a mobile unit associated with the NSBD and the baggage.

12) The method of claim 10 wherein the accelerometer is associated with the flight equipment of an aircraft.

13) A self-locating luggage unit, wherein the luggage unit comprises a piece of luggage in close proximity to a navigational system beacon device (NSBD), and wherein the NSBD comprises:
a) a component that can receive transmissions of position information;
b) a component that can store position information;
c) a component that can transmit position information; and
d) one or more accelerometers under the control of which the NSBD's transmission ability can be toggled off during take-off and toggled on during landing or after landing of an aircraft in which the luggage unit is located, or wherein the toggling on or off of the NSBD's transmission capacity is constrained by a history circuit comprising said accelerometers.

14) The self-locating luggage unit of claim 13, wherein the NSBD's close proximity to the piece of luggage is in a manner selected from the group consisting of: as an item within but not affixed to the piece of luggage; affixed to the inside of the piece of luggage; affixed to the outside of the piece of luggage; as an integral component of the piece of luggage;
affixed to a luggage dolly, and as an integral component of a luggage dolly.

15) The self-locating luggage unit of claim 13, wherein the NSBD further comprises a means for calculating the location of the luggage unit as a function of the relative location of satellite positions.

16) The self-locating luggage unit of claim 13, wherein when the transmission ability is on, its transmission can be periodic and or generated in response to a transmission from a central server or a client.

17) The self-locating luggage unit of claim 13, wherein the position information that can be stored comprises the relative location of satellites from which the NSBD has received transmissions of position information, and or comprises a calculated location of the luggage as a function of the relative location of the satellites.

18) An integrated system for tracking the location of a piece of luggage, comprising:
a) the piece of luggage;
b) a navigational system beacon device (NSBD) in close proximity to the piece of luggage, wherein the NSBD comprises
i) a component that can receive transmissions of position information;
ii) a component that can store position information;
iii) a component that can transmit position information; and
iv) an accelerometer under the control of which the NSBD's transmission ability can be toggled off during take-off and toggled on during landing or after landing of an aircraft in which the luggage unit is located, or under the control of which the toggling on or off of the NSBD's transmission capacity is constrained by a history circuit comprising said accelerometer;
c) a central server that can receive position information from the NSBD's transmissions and communicate position information to a client; and
d) a means for sending position information electronically to the client from the central server, and or a web site accessible to the client wherein the web site is capable of receiving and displaying position information.

19) The integrated system of claim 18, wherein the NSBD further comprises a means for calculating the location of the luggage unit as a function of the relative location of satellite positions.

20) The integrated system of claim 18, wherein the central server further comprises a means for calculating the location of the luggage unit as a function of the relative location of satellite positions.

21) The integrated system of claim 18, wherein the system further comprises at least one global positioning satellite the position information transmissions of which can be received by a component of the NSBD.

22) The integrated system of claim 18, wherein the NSBD's in close proximity to the piece of luggage is in a manner selected from the group consisting of: as an item within but not affixed to the piece of luggage; affixed to the inside of the piece of luggage; affixed to the outside of the piece of luggage; as an integral component of the piece of luggage; affixed to a luggage dolly, and as an integral component of a luggage dolly.

23) The integrated system of claim 18 wherein when the ability to transmit information from the NSBD is on, the transmission can be periodic and or generated in response to a transmission from the central server or a client.

24) The integrated system of claim 18 wherein the NSBD further comprises a means for calculating the location of the luggage unit as a function of supplemental data received from a cellular telephone, assisted GPS, and or an inertial navigational system.
